(19) United States
(12) Patent Application Publication
(10) Pub. No.: US 2016/0053755 A1
(43) Pub. Date: Feb. 25, 2016

(54) Control Valve And Variable Capacity Compressor Provided With Said Control Valve

(71) Applicant: SANDEN HOLDINGS CORPORATION, Isesaki-shi, Gunma (JP)

(72) Inventor: Yukihiko TAGUCHI, Isesaki-shi, Gunma (JP)

(21) Appl. No.: 14/779,283

(22) PCT Filed: Mar. 13, 2014
(86) PCT No.: PCT/JP2014/056794

§ 371 Date: Sep. 22, 2015

(30) Foreign Application Priority Data
Mar. 22, 2013 (JP) 2013-060998

(51) Int. Cl. F04B 49/22; F04B 27/18; F16K 31/06; F04B 53/10; F04B 53/14; F04B 27/10; F04B 39/00

(52) U.S. Cl. CPC F04B 49/22; F04B 27/1045; F04B 27/1054; F04B 27/18; F04B 39/0094; F04B 53/10; F04B 53/14; F04B 53/1082; F16K 31/0655; F16K 31/0675

(57) ABSTRACT

A control valve is disclosed that drives a valve body in a valve closing direction against urging forces of a bellows assembly and an open spring by an electromagnetic force generated in an electromagnetic coil portion by a drive current subjected to pulse width modulation. The control valve is provided with a notch portion formed in an inner peripheral wall of a through hole portion disposed in an end wall of a solenoid housing, so that a magnetic resistance between a peripheral wall of a movable iron core housed in a housing member and the inner peripheral wall of the through hole portion in a region of the notch portion differs from that in the other region around the movable iron core. In addition, a variable displacement compressor controls a refrigerant gas discharge displacement by use of this control valve.

### TECHNICAL FIELD

The present invention relates to a control valve that adjusts an electromagnetic force to adjust a valve opening degree. In addition, the present invention relates to a variable displacement compressor provided with this control valve.

### BACKGROUND ART

As this type of control valve, for example, there is a control valve applied to a use application to variably control a discharge displacement of a refrigerant gas of a variable displacement compressor for use in an air conditioning system for a vehicle, or the like (e.g., see Patent Document 1). In this control valve, as disclosed in Patent Document 1, a movable iron core coupled with a valve body that opens and closes a fluid passage in a valve housing is housed in a tubular housing member with a bottom, a drive coil portion is disposed around this housing member, and the movable iron core is driven along the housing member to drive the valve body by an electromagnetic force generated by the drive coil portion. Furthermore, in the above variable displacement compressor, this control valve is interposed in a pressure supply passage which allows a refrigerant gas discharge chamber of the variable displacement compressor to communicate with a crank chamber behind a piston, an opening degree of the pressure supply passage is controlled according to a pressure change in a refrigerant gas suction chamber to control a discharged refrigerant gas introduction amount into the crank chamber, and a stroke of the piston is changed, thereby varying a discharge displacement of the refrigerant gas.

### REFERENCE DOCUMENT LIST

### Patent Document

Patent Document 1: International Publication No. 2006/90760

### SUMMARY OF THE INVENTION

### Problems to be Solved by the Invention

When a control valve disclosed in Patent Document 1 is driven and controlled by pulse width modulation control (PWM control), a valve body operates while repeating collision with a valve seat in a flow rate control region in which a valve opening degree is small, i.e., the flow rate control region in which the valve body is disposed close to the valve seat. In this case, there is a concern that flow rate control characteristics of the control valve become unstable due to jumping of the valve body by the collision with the valve seat. In addition, a position of a movable iron core (i.e., the way the movable iron core is placed) coupled with the valve body also becomes unstable, and collision between an outer peripheral wall of the movable iron core and an inner peripheral wall of a housing member also repeatedly occurs. The collision between the outer peripheral wall of the movable iron core and the inner peripheral wall of the housing member becomes a vibration generation source of the control valve, and is one factor for noise generation from the control valve.

The present invention has been developed in view of the above problem, and an object thereof is to provide a control valve in which collision between a housing member and a movable iron core during driving of a valve body is reduced. In addition, an object of the present invention is to provide a variable displacement compressor provided with this control valve.

### Means for Solving the Problems

Therefore, a control valve of the present invention includes: a valve unit having a valve body that opens and closes a fluid passage in a valve housing and a movable iron core coupled with the valve body; a housing member having a tubular shape with a bottom and that houses the movable iron core; a drive coil portion disposed around the housing member; a solenoid housing that houses the drive coil portion, one end of which is fixed to the valve housing, and the other end of which is provided with an end wall covering an upside of the drive coil portion and having a through hole portion through which a bottom wall side end portion of the housing member is extended; and urging means for urging the valve unit in a valve opening direction. The control valve is configured to drive the valve body in a valve closing direction against an urging force of the urging means by an electromagnetic force generated in the drive coil portion by supply of a drive current subjected to pulse width modulation, wherein the electromagnetic force is adjusted, thereby adjusting an opening degree of the valve body. In the control valve, there is provided, around the movable iron core, a region in which a magnetic resistance between the movable iron core in the housing member and an inner peripheral wall of the through hole portion varies.

In addition, a variable displacement compressor of the present invention includes a pressure supply passage that allows a discharge chamber of a refrigerant gas to communicate with a control pressure chamber, and the control valve according to claim 1 interposed in the pressure supply passage. The control valve adjusts an opening degree of the pressure supply passage to control a pressure of the control pressure chamber, so as to make a discharge displacement of the refrigerant gas varied.

### Effects of the Invention

According to the control valve of the present invention, when a drive coil portion is energized, rattling of a movable iron core in a radial direction is reduced, and collision noise between the movable iron core and a housing member is reduced. In addition, a position of a coupled body of the movable iron core and a valve body becomes stable, and hence, an opening and closing operation of the valve body can be prevented from being unstable, whereby especially in the control valve driven by pulse width modulation control in a valve closing direction, it is possible to reduce disturbance of fluid control characteristics in a region in which a valve opening degree is small.

In addition, according to the variable displacement compressor of the present invention, noise to be radiated from the variable displacement compressor to the outside can be reduced by use of the control valve in which the collision noise between the movable iron core and the housing member is reduced. In addition, by use of the control valve in which stability of the opening and closing operation of the valve body is improved, precision of discharge displacement control characteristics of a fluid improves.

### BRIEF DESCRIPTION OF THE DRAWINGS

FIG. 1 is a cross-sectional view illustrating a variable displacement compressor according to an embodiment, in which a control valve of the present invention is used;

FIG. 2 is a cross-sectional view of a control valve according to a first embodiment of the present invention;

FIG. 3 is an enlarged cross-sectional view of a main part of the control valve of the first embodiment;

FIG. 4 is an enlarged cross-sectional view of a second end wall of a solenoid housing;

FIG. 5 is a state view of a second end wall portion seen from an arrow-A direction of FIG. 3;

FIG. 6 is an enlarged cross-sectional view of a main part of a control valve according to a second embodiment of the present invention;

FIG. 7 is a view illustrating a state seen from an arrow-B direction of FIG. 6;

FIG. 8 is a cross-sectional view of a main part of a control valve according to a third embodiment of the present invention;

FIG. 9 is a view illustrating a state seen from an arrow-C direction of FIG. 8;

FIG. 10 is a cross-sectional view of a main part of a control valve according to a fourth embodiment of the present invention;

FIG. 11 is a cross-sectional view of a movable iron core; and

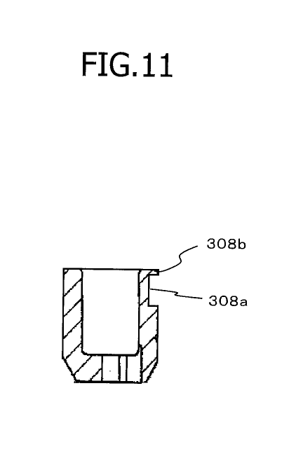

FIG. 12 is a view of the movable iron core seen from an arrow-D direction of FIG. 10.

### MODE FOR CARRYING OUT THE INVENTION

Hereinafter, embodiments of the present invention will be described with reference to the drawings.

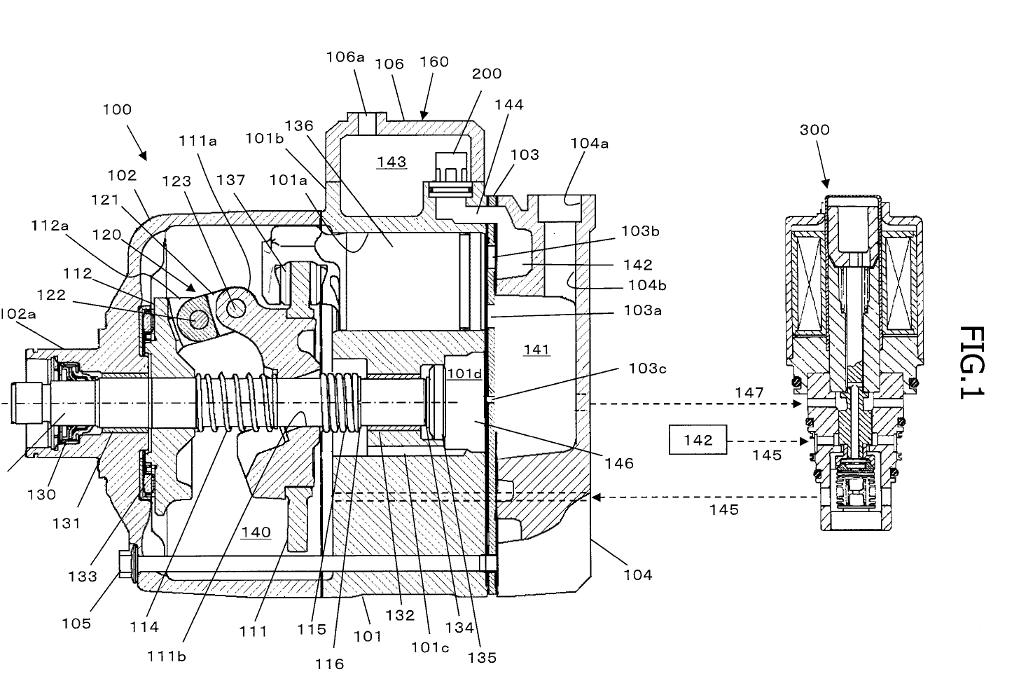

FIG. 1 illustrates a schematic constitution of a variable displacement compressor according to an embodiment, in which a control valve according to a first embodiment of the present invention is used, and illustrates an example of a clutchless variable displacement compressor for use in an air conditioning system for a vehicle.

In FIG. 1, a variable displacement compressor 100 includes a cylinder block 101 in which a plurality of cylinder bores 101a are formed, a front housing 102 disposed at one end of the cylinder block 101, and a cylinder head 104 disposed at the other end of the cylinder block 101 via a valve plate 103 and the like.

A drive shaft 110 is disposed to cross in a crank chamber 140 formed by the cylinder block 101 and the front housing 102. Around an intermediate portion of the drive shaft 110, a swash plate 111 is disposed. The swash plate 111 couples with a rotor 112 fixed to the drive shaft 110 via a link mechanism 120, and is supported by the drive shaft 110 so that an inclination angle is changeable.

The link mechanism 120 includes a first arm 112a projecting from the rotor 112, a second arm 111a projecting from the swash plate 111, and a link arm 121 having one end rotatably coupled with the first arm 112a via a first coupling pin 122 and having the other end rotatably coupled with the second arm 111a via a second coupling pin 123.

In the swash plate 111, there is formed a through hole 111b through which the drive shaft 110 extends. The through hole 111b is formed in such a shape that allows the swash plate 111 to incline in a range of a maximum inclination angle (θmax) to a minimum inclination angle (θmin), and in the through hole 111b, there is formed a minimum inclination angle regulating portion that abuts on the drive shaft 110. In a case in which the inclination angle of the swash plate 111 when the swash plate 111 is perpendicular to the drive shaft 110 is defined as 0°, the minimum inclination angle regulating portion of the through hole 111b is formed so that the swash plate 111 can be displaced up to an inclination angle of about 0°. It is to be noted that the maximum inclination angle of the swash plate 111 is regulated by allowing the swash plate 111 to abut on the rotor 112.

Between the rotor 112 and the swash plate 111, an inclination angle decreasing spring 114 that urges the swash plate 111 toward the minimum inclination angle is attached around the drive shaft 110. In addition, between the swash plate 111 and a spring support member 116 disposed in the drive shaft 110, an inclination angle increasing spring 115 that urges in a direction in which the inclination angle of the swash plate 111 increases is attached around the drive shaft 110. Here, an urging force of the inclination angle increasing spring 115 at the minimum inclination angle is set to be greater than an urging force of the inclination angle decreasing spring 114, and when the drive shaft 110 does not rotate, the swash plate 111 is positioned at the inclination angle at which the urging force of the inclination angle decreasing spring 114 and the urging force of the inclination angle increasing spring 115 are balanced.

One end of the drive shaft 110 extends through a boss portion 102a of the front housing 102 to extend to the outside of the front housing 102, and is coupled with a power transmitting device (not shown). Between the drive shaft 110 and the boss portion 102a, a shaft sealing device 130 is interposed, and an inner portion of the crank chamber 140 is cut off from an external space.

A coupled body of the drive shaft 110 and the rotor 112 is supported by bearings 131 and 132 in a radial direction, and supported by a bearing 133 and a thrust plate 134 in a thrust direction. A clearance between a portion on which the thrust plate 134 of the drive shaft 110 abuts and the thrust plate 134 is adjusted into a predetermined clearance by an adjusting screw 135. Furthermore, a power from an external drive source (an engine of the vehicle) is transmitted to the power transmitting device, and the drive shaft 110 rotates in synchronization with the power transmitting device.

In the cylinder bores 101a, a piston 136 is disposed, and an outer peripheral portion of the swash plate 111 is housed in an inside space of an end portion of the piston 136 which projects toward a crank chamber 140, so that the swash plate 111 interlocks with the piston 136 via a pair of shoes 137. Therefore, by the rotation of the swash plate 111, the piston 136 reciprocates in the cylinder bores 101a.

In the cylinder head 104, there are defined and formed a suction chamber 141 formed in a central portion and a discharge chamber 142 annularly surrounding the suction chamber 141. The suction chamber 141 communicates with the cylinder bores 101a via a suction hole 103a disposed in the valve plate 103 and a suction valve (not shown) formed in a suction valve forming body, and the discharge chamber 142 communicates with the cylinder bores 101a via a discharge hole 103b disposed in the valve plate 103 and a discharge valve (not shown) formed in a discharge valve forming body.

The front housing 102, the cylinder block 101, the valve plate 103, the suction valve forming body (not shown), the discharge valve forming body (not shown) and the cylinder head 104 are fastened by a plurality of through bolts 105 via gaskets (not shown), and a compressor housing is formed.

In the cylinder head 104, a suction port 104a and a suction passage 104b are formed, whereby the suction chamber 141 is connected to a low pressure side refrigerant circuit (a suction side refrigerant circuit) of the air conditioning system for the vehicle (a refrigerant device) via the suction port 104a and the suction passage 104b. The suction passage 104b is linearly extended to cross a part of the discharge chamber 142 from an outer side of the cylinder head 104 toward the suction chamber 141.

At the top of the cylinder block 101, there is disposed a muffler 160 that reduces noise and vibration due to pulsation of a refrigerant. The muffler 160 is formed by fastening a lid member 106 to a forming wall 101b defined and formed in the upper portion of the cylinder block 101 via a seal member (not shown) by use of bolts. In a muffler space 143 of the muffler 160, there is disposed a check valve 200 that reduces counter flow of the refrigerant gas from a discharge side refrigerant circuit to the discharge chamber 142.

The check valve 200 is disposed at a connecting portion between a communication path 144 formed across the cylinder head 104, the valve plate 103 and the cylinder block 101 to communicate with the discharge chamber 142, and the muffler space 143. The check valve 200 responds to a pressure difference between the communication path 144 (upstream side) and the muffler space 143 (downstream side) to operate, cuts off the communication path 144 when the pressure difference is less than a predetermined value, and opens the communication path 144 when the pressure difference is greater than the predetermined value. Therefore, the discharge chamber 142 is connected to the discharge side refrigerant circuit of the vehicle air conditioning system via a discharge passage constituted of the communication path 144, the check valve 200, the muffler space 143 and a discharge port 106a.

In the cylinder head 104, a control valve 300 of the present invention is disposed.

The control valve 300 is interposed in a pressure supply passage 145 that allows the discharge chamber 142 to communicate with the crank chamber 140 as a control pressure chamber behind the piston 136. In addition, a pressure of the suction chamber 141 is introduced via a pressure introduction passage 147. Furthermore, an opening degree of the pressure supply passage 145 that allows the discharge chamber 142 to communicate with the crank chamber 140 is adjusted so that the pressure of the suction chamber 141 is maintained at a predetermined value, and a discharged refrigerant gas introduction amount into the crank chamber 140 is controlled. In consequence, a pressure of the crank chamber 140 is changed by the control valve 300, and the inclination angle of the swash plate 111, i.e., a stroke of the piston 136 is changed, so that it is possible to variably control a discharge displacement of the variable displacement compressor 100. In addition, the refrigerant in the crank chamber 140 flows to the suction chamber 141 via a pressure release passage 146 extending through a communication path 101c, a space 101d and an orifice 103c formed in the valve plate 103.

There will specifically be described a constitution of the control valve 300 according to the first embodiment of the control valve of the present invention, which is used in the variable displacement compressor 100 described above.

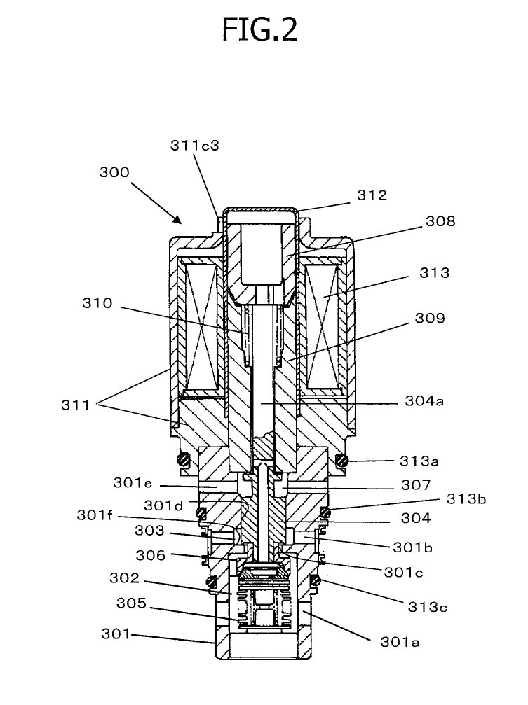

FIG. 2 is a cross-sectional view of the control valve 300 of the present embodiment. The control valve 300 includes: a first pressure sensing chamber 302 formed in a valve housing 301 and that communicates with the crank chamber 140 though the pressure supply passage 145 on a crank chamber 140 side via a communication hole 301a; a valve chamber 303 that communicates with the discharge chamber 142 through the pressure supply passage 145 on a discharge chamber 142 side via a communication hole 301b; a valve hole 301c that allows the first pressure sensing chamber 302 to communicate with the valve chamber 303; a valve body 304 having one end side contacted with and separated from a valve seat 301f around the valve hole 301c to open and close the valve hole 301c and having the other end side slidably inserted into a support hole 301d formed in the valve housing 301; a bellows assembly 305 having a spring in an inner portion in which a vacuum is created, and disposed in the first pressure sensing chamber 302 to receive the pressure of the crank chamber 140; a coupling portion 306 having one end contactably and separably coupled with the bellows assembly 305 and having the other end fixed to one end of the valve body 304 to transmit displacement of the bellows assembly 305 to the valve body 304; a second pressure sensing chamber 307 that communicates with the suction chamber 141 through the pressure introduction passage 147 via a communication hole 301e; a solenoid rod 304a having one end side integrally coupled with the valve body 304 disposed in the second pressure sensing chamber 307 and having the other end side into which a movable iron core 308 is pressed and fixed; a fixed iron core 309 into which the solenoid rod 304a is inserted and which is disposed to face the movable iron core 308 via a predetermined clearance; an open spring 310 interposed between the fixed iron core 309 and the movable iron core 308 to elastically urge the valve body 304 in a valve opening direction via the movable iron core 308 and the solenoid rod 304a; a housing member 312 formed into a tubular shape with a bottom and made of a nonmagnetic material and in which the fixed iron core 309 and the movable iron core 308 are housed so that the movable iron core 308 is disposed in the vicinity of a bottom wall side end portion; an electromagnetic coil portion 313 as a drive coil portion disposed in an outer periphery of the housing member 312 and having a surface covered with a resin; and a solenoid housing 311 that houses the electromagnetic coil portion 313. Here, the valve body 304, the solenoid rod 304a and the movable iron core 308 constitute a valve unit. In addition, the movable iron core 308, the fixed iron core 309 and the solenoid housing 311 constitute a magnetic circuit when the electromagnetic coil portion 313 is energized.

It is to be noted that a clearance between an outer peripheral surface of the valve body 304 and an inner surface of the support hole 301d and a clearance between an outer peripheral surface of the movable iron core 308 and an inner surface of the peripheral wall 312a of the housing member 312 are adjusted so that, when one point of the outer peripheral surface of the valve body 304 of the valve unit abuts on the inner surface of the support hole 301d, one point of the outer peripheral surface of the movable iron core 308 of the valve unit which is present at a diagonal position to the above abutment position abuts on the inner surface of the after-mentioned peripheral wall 312a of the housing member 312, whereby the valve unit is supported at two points on a diagonal. In consequence, it is possible to avoid the disadvantages that the valve body 304 is supported at two points in the support hole 301d and that the movable iron core 308 is supported at two points on the inner surface of the peripheral wall 312a of the housing member 312, and the valve unit can smoothly be slid without disturbing movement of the valve unit in an axial direction of the valve unit (an opening and closing direction of the valve body 304).

Additionally, in an outer peripheral portion of the control valve 300, three O-rings 313a to 313c are disposed, and a housing space of the control valve 300 formed in the cylinder head 104 is divided into a region in which the pressure of the suction chamber 141 acts, a region in which the pressure of the discharge chamber 142 acts and a region in which the pressure of the crank chamber 140 acts, by the O-rings 313a to 313c.

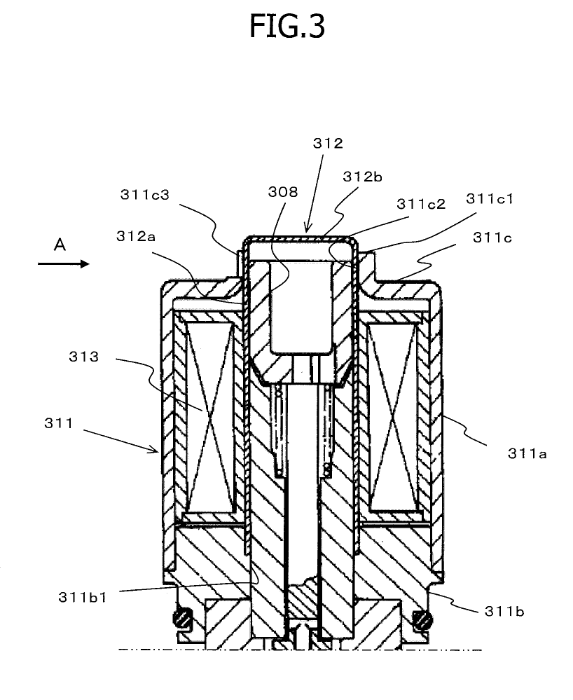

Next, a main part of the control valve 300 of the present embodiment will be described in detail with reference to FIG. 3 to FIG. 5.

The solenoid housing 311 includes a cylindrical peripheral wall 311a covering a periphery of the electromagnetic coil portion 313, a first end wall 311b that closes one end of the peripheral wall 311a and in which a through hole 311b1 is formed in a central portion, and a second end wall 311c formed integrally with the peripheral wall 311a to cover the upside of the electromagnetic coil portion 313 and to close the other end of the peripheral wall 311a. The second end wall 311c has a through hole portion 311c1 through which a side end portion of a bottom wall 312b of the housing member 312 is extended, and the through hole portion 311c1 is vertically disposed on an outer side (an upper side in FIG. 3) so that an inner peripheral wall 311c2 of the through hole portion surrounds the movable iron core 308 in the housing member 312. Therefore, the second end wall 311c corresponds to an end wall covering the upside of the drive coil portion and having the through hole portion through which the bottom wall side end portion of the housing member 312 is extended. Furthermore, one end of the peripheral wall 311a is positioned and fixed to an outer periphery of the first end wall 311b, and the first end wall 311b is fixed to the valve housing 301. It is to be noted that the peripheral wall 311a and the second end wall 311c may be constituted of separate members.

The housing member 312 is constituted of the cylindrical peripheral wall 312a, and the bottom wall 312b (the upper side of FIG. 3) that closes one end of the peripheral wall 312a, and an opening end side (a lower side of FIG. 3) of the peripheral wall 312a is positioned on a peripheral wall of the through hole 311b1 of the solenoid housing 311 and is integrated with the solenoid housing 311.

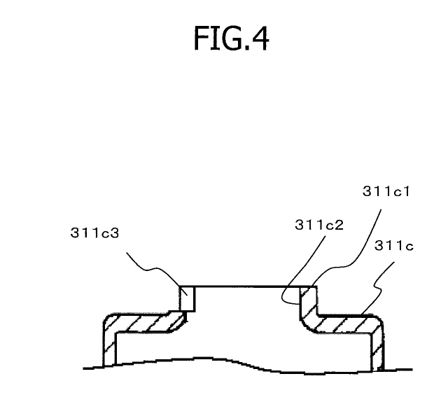

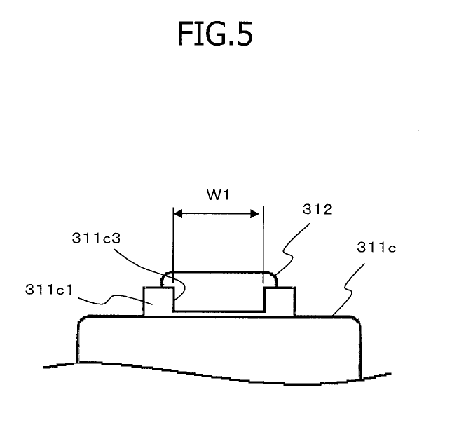

The through hole portion 311c1 of the second end wall 311c of the solenoid housing 311 is formed so that the inner peripheral wall 311c2 of the through hole portion surrounds the movable iron core 308 via the peripheral wall 312a of the housing member 312, and the through hole portion serves as a magnetic transfer portion to the movable iron core 308. In the through hole portion 311c1, as illustrated in FIG. 4 and FIG. 5, a rectangular notch portion 311c3 is formed in a region W1 of a part of the through hole portion and a height (an upward-downward direction of the drawing) of the through hole portion is set to be low. In consequence, the region W1 has a constitution in which an area facing an outer peripheral wall of the movable iron core 308 is smaller than that in the other region of the inner peripheral wall 311c2 of the through hole portion 311c1, and a magnetic resistance between the region W1 and the movable iron core 308 is greater than that of the other region of the inner peripheral wall 311c2 of the through hole portion 311c1, when the electromagnetic coil portion 313 is energized.

A control operation of the control valve 300 of such a constitution will briefly be described.

When a bellows effective area Sb of the bellows assembly 305, a pressure receiving area Sv of the crank chamber 140 that receives, from a valve hole 301c side, the pressure acting on the valve body 304, and a pressure receiving area Sr of the suction chamber 141 that receives the pressure acting on the valve body 304 in the second pressure sensing chamber 307, are set to about the same value, a force acting on the valve body 304 is represented by the following equation (1).

Ps=−(1/Sb)·F(i)+(F+f)/Sb (1),

in which Ps is the pressure of the suction chamber 141, F(i) is an electromagnetic force, f is an urging force of the open spring 310, and F is an urging force of the bellows assembly 305. It is to be noted that any frictional force is not taken into consideration in Equation (1).

From the above equation (1), the pressure of the suction chamber 141 is determined by a current value of the electromagnetic coil portion 313. During the energization of the electromagnetic coil portion 313, the electromagnetic force acts on the valve body 304 in a valve closing direction via the movable iron core 308 and the solenoid rod 304a. Therefore, when an energization amount to the electromagnetic coil portion 313 increases, a force in such a direction as to decrease the opening degree of the pressure supply passage 145 is increased, the pressure of the crank chamber 140 is reduced, the discharge displacement is increased, and the pressure of the suction chamber 141 changes in a lowering direction. When the energization amount to the electromagnetic coil portion 313 decreases, the valve body operates in such a direction as to increase the opening degree of the pressure supply passage 145, the pressure of the crank chamber 140 is increased, and the discharge displacement is reduced to change the pressure of the suction chamber 141 in a rising direction. In consequence, the control valve 300 performs autonomous control of the opening degree of the pressure supply passage 145 so that the pressure of the suction chamber 141 is maintained at a set pressure set according to a current value of the electromagnetic coil portion 313.

In the variable displacement compressor 100 including the control valve 300, during an operation of an air conditioner, i.e., in an operation state of the variable displacement compressor 100, the energization amount to the electromagnetic coil portion 313 is adjusted based on air condition setting or external environment, and the opening degree of the pressure supply passage 145 is controlled so that the pressure of the suction chamber 141 becomes the set pressure corresponding to the energization amount, whereby the discharge displacement is controlled. In addition, during a non-operation of the air conditioner, i.e., in a non-operation state of the variable displacement compressor 100, energization to the electromagnetic coil portion 313 is OFF, whereby the pressure supply passage 145 is opened by the open spring 310 and the discharge displacement is controlled into a minimum state.

In the control valve 300 of the present embodiment, the movable iron core 308 is constituted to be movable in the radial direction (a right-left direction of FIG. 3) in a range of a clearance between an outer peripheral wall of the movable iron core 308 and the inner surface of the peripheral wall 312a of the housing member 312. In addition, the valve body 304 is also constituted to be movable in the radial direction in a range of a clearance between an outer peripheral wall of the valve body 304 and an inner peripheral wall of the support hole 301d of the valve housing 301. Furthermore, the coupled body (the valve unit) of the valve body 304, the solenoid rod 304a and the movable iron core 308 is driven at a predetermined frequency in a range of 400 Hz to 500 Hz by pulse width modulation control (PWM control), and during the energization of the electromagnetic coil portion 313, the coupled body repeatedly receives an external force corresponding to a generated current amplitude to vibrate in an axial direction (the opening and closing direction of the valve body 304). At this time, the magnetic resistance between the through hole portion 311c1 of the solenoid housing 311 and the movable iron core 308 in the region W1 of the through hole portion 311c1 differs from that in the other region, and a side force acts in the radial direction of the movable iron core 308 due to unbalance of the magnetic resistance around the movable iron core 308. Furthermore, the movable iron core 308 is drawn in a direction in which the magnetic resistance is less (on an opposite side to the region W1), so that one point of the outer peripheral wall of the movable iron core abuts on the inner surface of the peripheral wall 312a of the housing member 312. Additionally, one point of the outer peripheral wall of the valve body 304 which is present at the diagonal position to the abutment position of the movable iron core 308 abuts on the inner surface of the support hole 301d, and the valve unit is slidably supported at two points on the diagonal.

Therefore, according to the control valve 300 of such a constitution, during the energization of the electromagnetic coil portion 313, rattling of the movable iron core 308 in the radial direction is reduced, and collision noise between the movable iron core 308 and the housing member 312 is reduced. In addition, a position of the valve unit including the coupled body of the movable iron core 308, the solenoid rod 304a and the valve body 304 becomes stable, and hence, the opening and closing of the valve hole 301c is prevented from being unstable. In particular, even when the opening degree of the valve body 304 is small and the valve body 304 repeats the contacting and separating operation to the valve seat 301f due to the current amplitude by the PWM control or by self-excited vibration of the coupled body of the valve body 304, the solenoid rod 304a, the movable iron core 308 and the bellows assembly 305, the movable iron core 308 is drawn in the direction in which the magnetic resistance is less (on the opposite side to the region W1) to abut on the inner surface of the peripheral wall 312a of the housing member 312. Furthermore, one point of the outer peripheral wall of the valve body 304 which is present at the diagonal position to the abutment position of the movable iron core 308 abuts on the inner surface of the support hole 301d, and the valve unit comprising the coupled body of the valve body 304, the solenoid rod 304a and the movable iron core 308 is slidably supported at two points on the diagonal, so that the position of the valve unit becomes stable and the opening and closing of the valve hole 301c is prevented from being unstable. In consequence, pressure control characteristics of the suction chamber 141 by the control valve 300 are prevented from being disturbed. Furthermore, when the opening degree of the valve body 304 is small, the electromagnetic force is strong, and a suction force strengthens, so that the stability of the position of the coupled body of the valve body 304, the solenoid rod 304a and the movable iron core 308 increases, and the disturbance of the pressure control characteristics of the suction chamber 141 can further be reduced.

When the movable iron core 308 moves in the axial direction (an upward-downward direction of FIG. 3), a sliding resistance corresponding to the electromagnetic force acts between the outer peripheral wall of the movable iron core 308 and the inner surface of the peripheral wall 312a of the housing member 312, but when the side force excessively increases due to the unbalance of the magnetic resistance, there is a concern that the movable iron core 308 cannot smoothly move in the axial direction. Therefore, a shape of the notch portion 311c3 is determined so that the rattling of the movable iron core 308 in the radial direction is reduced and so that the movable iron core 308 can smoothly move in the radial direction due to the current amplitude by the PWM control. It is to be noted that the shape of the notch portion 311c3 is not limited to a rectangular shape and may be any shape, e.g., an inverted triangular shape. In addition, the through hole portion 311c1 may obliquely be cut so that the height of the through hole portion 311c1 gradually varies.

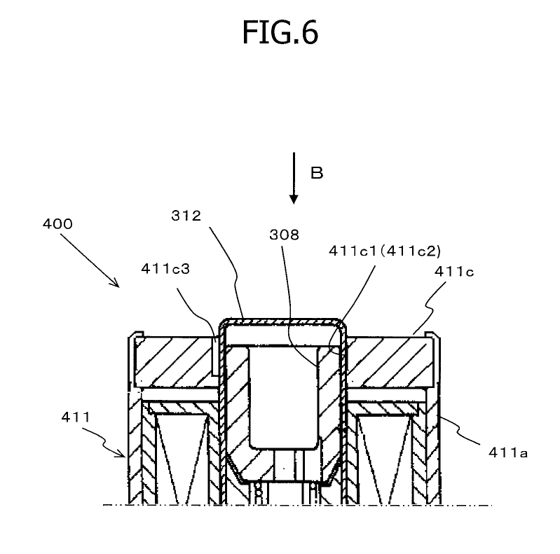

Next, FIG. 6 illustrates a main part of a control valve according to a second embodiment of the present invention. It is to be noted that the same elements as in the abovementioned first embodiment are denoted with the same reference symbols.

A control valve 400 of this embodiment has a constitution in which a clearance between an inner peripheral wall of a through hole portion of a second end wall and a peripheral wall of a housing member varies around a movable iron core.

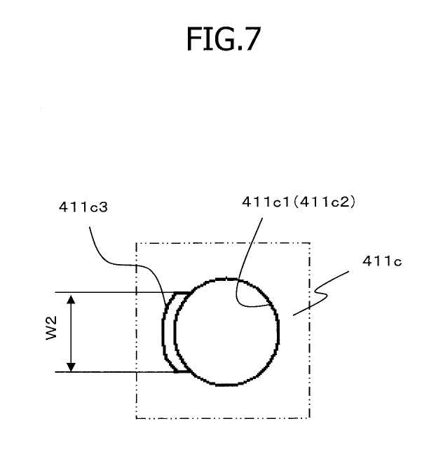

The control valve 400 has a constitution similar to the first embodiment, except that a second end wall 411c of a solenoid housing 411 is constituted of a member separate from a peripheral wall 411a. The second end wall 411c is in the form of a flat plate, and is fixed to an end portion of the peripheral wall 411a by bending and caulking the end portion of the peripheral wall 411a of the solenoid housing 411. Additionally, as illustrated in FIG. 7, a through hole portion 411c1 through which a housing member 312 is extended is formed in a central portion of the second end wall 411c, and a notch portion 411c3 is formed in a region W2 of a part of an inner peripheral wall 411c2 of the through hole portion, whereby a height of the inner peripheral wall 411c2 (an upward-downward direction of FIG. 6) is set to be low as illustrated in FIG. 6. The region W2 of the notch portion 411c3 is a region in which a clearance between the inner peripheral wall 411c2 of the through hole portion 411c1 and a peripheral wall 312a of the housing member 312 differs from that in the other region, and the clearance in the region W2 is greater than that in the other region of the inner peripheral wall 411c2. The inner peripheral wall 411c2 of the through hole portion 411c1 surrounds a movable iron core 308 in the housing member 312 to serve as a magnetic transfer portion to the movable iron core 308, and when an electromagnetic coil portion 313 is energized, a magnetic resistance between the region W2 of the inner peripheral wall 411c2 of the through hole portion 411c1 and the movable iron core 308 is greater than that in the other region of the peripheral wall 411c2 of the through hole portion 411c1.

According to the control valve 400, in the same manner as in the first embodiment, a side force acts in a radial direction of the movable iron core 308 due to unbalance of the magnetic resistance when the electromagnetic coil portion 313 is energized, and the movable iron core 308 is attracted in a direction in which the magnetic resistance is less (on an opposite side to the region W2) to abut on an inner surface of the peripheral wall 312a of the housing member 312. Furthermore, one point of an outer peripheral wall of a valve body 304 which is present at a diagonal position to an abutment position of the movable iron core 308 abuts on an inner surface of a support hole 301d, and a valve unit including a coupled body of the valve body 304, a solenoid rod 304a and the movable iron core 308 is slidably supported at two points on a diagonal. Therefore, rattling of the movable iron core 308 in the radial direction is reduced, and collision noise between the movable iron core 308 and the housing member 312 is reduced. Additionally, a position of the valve unit which is the coupled body of the movable iron core 308, the solenoid rod 304a and the valve body 304 becomes stable, and opening and closing of a valve hole 301c is prevented from being unstable. It is to be noted that any size of the side force acting in the radial direction of the movable iron core 308 can be set by adjusting, for example, a width and a depth of the notch portion 411c3.

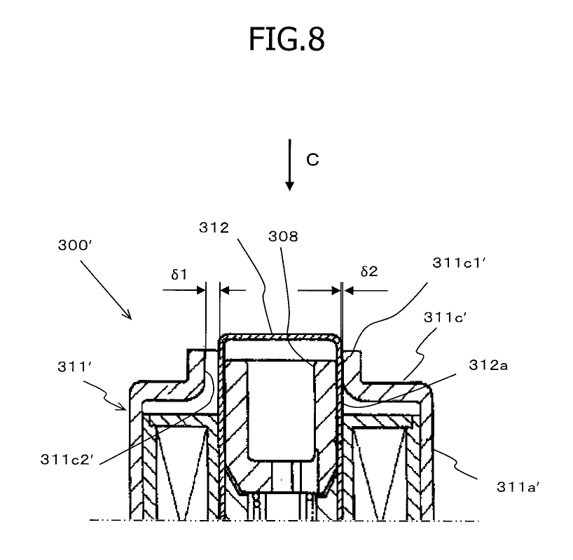

FIG. 8 illustrates a main part of a control valve according to a third embodiment of the present invention. It is to be noted that the same elements as in the first embodiment are denoted with the same reference symbols.

In FIG. 8, a control valve 300′ of the present embodiment is another example of a constitution in which a clearance between an inner peripheral wall of a through hole portion of a second end wall and a peripheral wall of a movable iron core varies around the movable iron core. The control valve 300′ has a constitution in which an axial center of a through hole portion 311c1′ in a second end wall 311c′ of a solenoid housing 311′ is shifted (offset) with respect to an axial center of a housing member 312. The other constitution is the same as in the first embodiment.

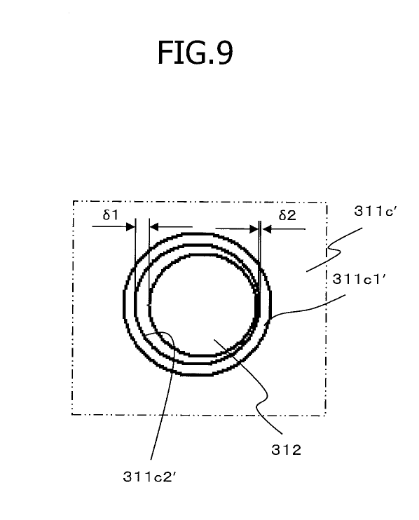

In the control valve 300′ of such a constitution, a clearance between an inner peripheral wall 311c2′ of the through hole portion 311c1′ and an inner surface of a peripheral wall 312a of the housing member 312 varies around a movable iron core 308, and as illustrated in FIG. 9, regions of a maximum clearance δ1 and a minimum clearance δ2 can be made. In consequence, when an electromagnetic coil portion 313 is energized, a side force acts in a radial direction of the movable iron core 308 due to unbalance of a magnetic resistance, and the movable iron core 308 is attracted in a direction in which the magnetic resistance is less (on a minimum clearance δ2 side) to abut on an inner surface of the peripheral wall 312a of the housing member 312. Furthermore, one point of an outer peripheral wall of a valve body 304 which is present at a diagonal position to an abutment position of the movable iron core 308 abuts on an inner surface of a support hole 301d, and a valve unit including a coupled body of the valve body 304, a solenoid rod 304a and the movable iron core 308 is slidably supported at two points on a diagonal. Therefore, rattling of the movable iron core 308 in the radial direction is reduced, and a position of the valve unit which is the coupled body of the movable iron core 308, the solenoid rod 304a and the valve body 304 becomes stable, so that collision noise between the movable iron core 308 and the housing member 312 can be reduced and opening and closing of a valve hole 301c can be prevented from being unstable. It is to be noted that any size of the side force acting in the radial direction of the movable iron core 308 can be set by adjusting, for example, a diameter and an offset amount of the through hole portion 311c1′.

It is to be noted that an axial center of the housing member 312 and an axial center of the through hole portion 311c1′ are coaxial as in the first embodiment and a notch such as the notch portion 411c3 in the second embodiment illustrated in FIG. 6 is formed along a total length of the through hole portion 311c1′ (an upward-downward direction of FIG. 8), whereby a clearance between the inner peripheral wall 311c2′ of the through hole portion 311c1′ and the peripheral wall 312a of the housing member 312 may be varied around the movable iron core 308.

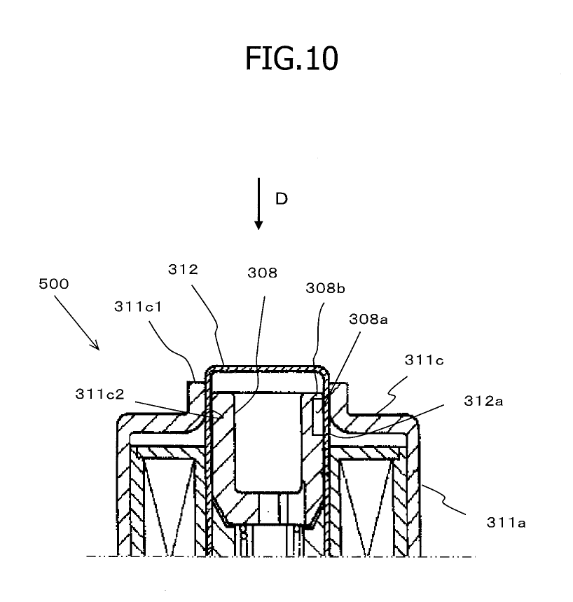

FIG. 10 illustrates a main part of a control valve according to a fourth embodiment of the present invention. It is to be noted that the same elements as in the first embodiment are denoted with the same reference symbols.

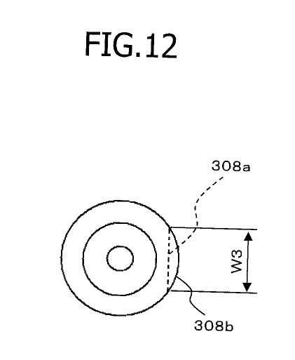

A control valve 500 of the present embodiment has a constitution in which a clearance between a peripheral wall of a movable iron core 308 facing an inner peripheral wall 311c2 of a through hole portion 311c1 of a second end wall 311c across a housing member 312, and an inner surface of a peripheral wall 312a of the housing member 312, varies around the movable iron core 308. Specifically, a notch portion 308a is formed in a part of the peripheral wall of the movable iron core 308. In a region W3 (illustrated in FIG. 12) of the notch portion 308a, a clearance between the inner surface of the peripheral wall 312a of the housing member 312 and the peripheral wall of the movable iron core 308 is greater than that in the other region around the movable iron core 308. Since an upper end peripheral edge 308b of the movable iron core 308 serves as an abutment portion abutting on the inner surface of the peripheral wall 312a of the housing member 312, the notch portion 308a is formed in a peripheral wall portion on a lower side than the upper end peripheral edge 308b of the movable iron core 308. The other constitution of the control valve 500 except the movable iron core 308 is similar to the first embodiment.

In the control valve 500 of such a constitution, a distance between the region W3 of the notch portion 308a of the movable iron core 308 and the inner peripheral wall 311c2 of the through hole portion 311c1 is greater than that in the other region of the peripheral wall of the movable iron core 308, and a magnetic resistance increases. In consequence, when an electromagnetic coil portion 313 is energized, unbalance of the magnetic resistance occurs, and a side force acts in a radial direction of the movable iron core 308 to draw the movable iron core 308 in a direction in which the magnetic resistance is less (on an opposite side to the region W3), whereby the movable iron core abuts on the inner surface of the peripheral wall 312a of the housing member 312. Furthermore, one point of an outer peripheral wall of a valve body 304 which is present at a diagonal position to an abutment position of the movable iron core 308 abuts on an inner surface of a support hole 301d, and a valve unit comprising a coupled body of the valve body 304, a solenoid rod 304a and the movable iron core 308 is slidably supported at two points on a diagonal. Therefore, in the same manner as in the abovementioned embodiments, rattling of the movable iron core 308 in the radial direction is reduced and collision noise between the movable iron core 308 and the housing member 312 is reduced, and additionally, a position of the valve unit which is the coupled body of the movable iron core 308, the solenoid rod 304a and the valve body 304 becomes stable and opening and closing of a valve hole 301c is prevented from being unstable. It is to be noted that a size of the side force acting in the radial direction of the movable iron core 308 can be adjusted by, for example, a width and a depth of the notch portion 308a.

It is to be noted that in the above embodiments, when one point of the outer peripheral surface of the valve body of the valve unit abuts on the inner surface of the support hole, the outer peripheral surface of the movable iron core abuts on the inner surface of the peripheral wall of the housing member, but the present invention is not limited to this structure. For example, the outer peripheral surface of the movable iron core is not allowed to abut on the inner surface of the peripheral wall of the housing member, but the solenoid rod may be allowed to abut on a solenoid rod insertion hole of the fixed iron core. In this case, when the side force acts in the radial direction of the movable iron core due to the unbalance of the magnetic resistance to attract the movable iron core in the direction in which the magnetic resistance is less, the solenoid rod abuts on the solenoid rod insertion hole of the fixed iron core, and the valve unit is slidably supported at two points on the diagonal, i.e., the solenoid rod and the valve body.

Additionally, in the above embodiments, both the movable iron core and the fixed iron core are housed in the housing member, but there may be provided a structure in which at least the movable iron core is housed in the housing member.

Additionally, in the embodiments, the electromagnetic coil portion and the second end wall of the solenoid housing are separately constituted, but the peripheral wall of the solenoid housing and the second end wall may be constituted of separate members, and the second end wall may be integrated with the electromagnetic coil portion and covered with a resin to obtain a molded coil.

Additionally, in the embodiments, there has been illustrated the control valve including the pressure sensing member (the bellows assembly), but the electromagnetic coil portion may be driven by the pulse width modulation to control the opening degree of the fluid passage in the valve housing. In this case, any pressure sensing means does not have to be provided.

Additionally, in the embodiments, there has been illustrated the example of the control valve for use in the discharge displacement control of the variable displacement compressor to be used in the air conditioning system for the vehicle, or the like, but a use application is not limited to this example, and the control valve of the present invention is applicable to any use application, as long as opening and closing control of the fluid passage is required.

Additionally, in the above embodiments, the example of the reciprocating type variable displacement compressor has been illustrated as the variable displacement compressor in which the control valve of the present invention is used, but the variable displacement compressor in which the control valve of the present invention can be used may be any type of variable displacement compressor.

### REFERENCE SYMBOL LIST

100 Variable displacement compressor
136 Piston
140 Crank chamber (control pressure chamber)
141 Suction chamber
142 Discharge chamber
145 Pressure supply passage
300, 300′, 400 and 500 Control valve
301 Valve housing
304 Valve body
304a Solenoid rod
308 Movable iron core
308a Notch portion
311, 311′ and 411 Solenoid housing
311a, 311a′ and 411a Peripheral wall
311c and 411c Second end wall
311c1 and 411c1 Through hole portion
311c2 and 411c2 Inner peripheral wall (of a through hole)
311c3 and 411c3 Notch portion
312 Housing member
313 Electromagnetic coil portion

1. A control valve comprising:
a valve unit having a valve body that opens and closes a fluid passage in a valve housing and a movable iron core coupled with the valve body;
a housing member having a tubular shape with a bottom and that houses the movable iron core;
a drive coil portion disposed around the housing member;
a solenoid housing that houses the drive coil portion, one end of which is fixed to the valve housing, and the other end of which is provided with an end wall covering an upside of the drive coil portion and having a through hole portion through which a bottom wall side end portion of the housing member is extended; and
urging means for urging the valve unit in a valve opening direction,
the control valve being configured to drive the valve body in a valve closing direction against an urging force of the urging means by an electromagnetic force generated in the drive coil portion by supply of a drive current subjected to pulse width modulation, wherein the electromagnetic force is adjusted, thereby adjusting an opening degree of the valve body,
wherein there is provided, around the movable iron core, a region in which a magnetic resistance between the movable iron core in the housing member and an inner peripheral wall of the through hole portion varies.

2. The control valve according to claim 1,
wherein when the valve body is slidably inserted into a support hole formed in the valve housing and the drive coil portion is energized, the movable iron core is drawn in a direction in which the magnetic resistance is less, one point of an outer peripheral wall of the movable iron core abuts on an inner surface of a peripheral wall of the housing member, one point of an outer peripheral surface of the valve body which is present at a diagonal position to an abutment position of the movable iron core abuts on an inner surface of the support hole, and the valve unit is slidably supported at two points on a diagonal.

3. The control valve according to claim 1,
wherein the inner peripheral wall of the through hole portion of the end wall has a region in which a height varies.

4. The control valve according to claim 1,
wherein a clearance between the inner peripheral wall of the through hole portion of the end wall and a peripheral wall of the housing member varies around the movable iron core.

5. The control valve according to claim 4,
wherein an axial center of the through hole portion of the end wall is shifted with respect to an axial center of the housing member.

6. The control valve according to claim 4,
wherein a notch portion is formed in the inner peripheral wall of the through hole portion of the end wall.

7. The control valve according to claim 1,
wherein a notch portion is formed in a peripheral wall of the movable iron core facing the inner peripheral wall of the through hole portion of the end wall across the housing member.

8. A variable displacement compressor comprising:
a pressure supply passage that allows a discharge chamber of a refrigerant gas to communicate with a control pressure chamber; and
the control valve according to claim 1 interposed in the pressure supply passage,
wherein the control valve adjusts an opening degree of the pressure supply passage to control a pressure of the control pressure chamber, so as to make a discharge displacement of the refrigerant gas varied.
